(19) United States
(12) Patent Application Publication
(10) Pub. No.: US 2009/0328127 A1
(43) Pub. Date: Dec. 31, 2009

(54) System and method for implementing a personal information mode in an electronic device

(75) Inventors: Keith Barry, San Diego, CA (US); Rafael Calderon, San Diego, CA (US); Jorge Hernandez, San Diego, CA (US); Dan Jastorff, San Diego, CA (US); Rolando Zorrilla, San Diego, CA (US)

Correspondence Address: Gregory J. Koerner;Redwood Patent Law, 1291 East Hillsdale Boulevard, Suite 205, Foster City, CA, 94404, US

(73) Assignees: Sony Corporation; Sony Electronics Inc.

(21) Appl. No.: 12/215,263

(22) Filed: Jun. 26, 2008

(51) Int. Cl. H04N 7/16

(52) U.S. Cl. 725/153

(57) ABSTRACT

A system and method for implementing a personal information mode in a television device includes personal information data that is selectably accessed from at least one remote information source. A display of the television device is configured to display a personal information interface to a system user. A personal information module of the television then automatically displays the personal information to the system user on the personal information interface.

### BACKGROUND SECTION

1. Field of the Invention

This invention relates generally to techniques for implementing electronic devices, and relates more particularly to a system and method for implementing a personal information mode in an electronic device.

2. Description of the Background Art

Implementing effective methods for providing electronic information to device users is a significant consideration for designers and manufacturers of contemporary electronic devices. However, effectively providing information utilized by device users may create substantial challenges for system designers. For example, enhanced demands for increased information resources may require more system processing power and require additional software capabilities. An increase in processing or software requirements may also result in a corresponding detrimental economic impact due to increased production costs and operational inefficiencies.

Furthermore, enhanced device capability to perform various advanced operations may provide additional benefits to a system user, but may also place increased demands on the control and management of various system components. For example, an enhanced electronic network device that requires various types of image data may benefit from an effective implementation because of the large amount and complexity of the digital data involved.

Due to growing demands on system resources and substantially increasing data magnitudes, it is apparent that developing new techniques for providing electronic information to users of electronic devices is a matter of concern for related electronic technologies. Therefore, for all the foregoing reasons, developing effective techniques for providing required electronic information remains a significant consideration for designers, manufacturers, and users of contemporary electronic devices.

### SUMMARY

In accordance with the present invention, a system and method for implementing a personal information mode in an electronic device are disclosed. In one embodiment, a television advantageously supports a personal information (PI) mode that automatically provides various types of desired personal information for utilization by a system user. For example, the personal information may be displayed on the television as one or more PI display pages, and may include configurable and relevant information such as current news, weather, traffic, sports, and financial information. The PI mode may also support various local PI applications on the television, such as a calendar, a clock, maps, games, and audio/video applications.

In certain embodiments, the television may access a server through an intervening network to obtain current information for updating the personal information on the PI display page. The network may be implemented to include any desired types or combinations of electronic networks or other entities, including, but not limited to, a cable network and/or the Internet. The server may obtain the foregoing current information in any effective manner. In addition, in certain embodiments, the server may serve as a gateway device to provide appropriate links or connection information for the television to directly communicate with other information sources in the network or elsewhere to thereby obtain required personal information for presentation to the system user.

In one embodiment, a personal information module of the television may initially determine whether a PI mode configuration procedure has been initiated to allow a system user to configure the personal information mode for presenting various types of personal information on the television. If the PI mode configuration procedure has been initiated, then the personal information module interactively allows the system user to specify any supported operational characteristics for the personal information mode.

In addition, the personal information module typically monitors the server to determine whether there have been any change in certain user-specified personal information that the server provides to the television. If any changes have occurred in the user-specified personal information provided through the server, then the personal information module accesses the new personal information and updates corresponding PI data stored in a local TV memory of the television.

During typical operations, the personal information module determines whether the personal information mode is currently activated for providing personal information to the system user. If the personal information mode is not activated, then the television may display regular television programming from any appropriate source in a normal TV display mode. However, if the personal information mode is currently activated, then the personal information module determines which PI display mode has been selected for the television. If a PI-only display mode has been selected, then the television displays only one or more personal information display pages in any effective manner. For example, in certain embodiments, a personal information display page may be displayed using either a full screen or a partial screen of the television.

In contrast, if a combination display mode has been selected, then the television displays the one or more personal information display pages in conjunction with the regular television programming in any effective manner. For example, in certain embodiments, the one or more personal information display pages may be displayed in a smaller window (picture-in-picture) within the regular television programming on the television. For all of the foregoing reasons, the present invention therefore provides an improved system and method for implementing a personal information mode in an electronic device.

### BRIEF DESCRIPTION OF THE DRAWINGS

FIG. 1 is a block diagram illustrating a personal information system, in accordance with one embodiment of the present invention;

FIG. 2 is a block diagram for one embodiment of the server of FIG. 1, in accordance with the present invention;

FIG. 3 is a block diagram for one embodiment of the server memory of FIG. 2, in accordance with the present invention;

FIG. 4 is a block diagram for one embodiment of the current information of FIG. 3, in accordance with the present invention;

FIG. 5 is a block diagram for one embodiment of the television of FIG. 1, in accordance with the present invention;

FIG. 6 is a block diagram for one embodiment of the TV memory of FIG. 5, in accordance with the present invention;

FIG. 7 is a block diagram for one embodiment of the PI data from FIG. 6, in accordance with the present invention;

FIG. 8 is a diagram for one embodiment of the PI applications from FIG. 6, in accordance with the present invention;

FIG. 9 is a flowchart of method steps for supporting a personal information mode, in accordance with one embodiment of the present invention; and

FIG. 10 is a flowchart of method steps for utilizing a personal information mode, in accordance with one embodiment of the present invention.

### DETAILED DESCRIPTION

The present invention relates to an improvement in techniques for implementing electronic devices. The following description is presented to enable one of ordinary skill in the art to make and use the invention, and is provided in the context of a patent application and its requirements. Various modifications to the disclosed embodiments will be apparent to those skilled in the art, and the generic principles herein may be applied to other embodiments. Therefore, the present invention is not intended to be limited to the embodiments shown, but is to be accorded the widest scope consistent with the principles and features described herein.

The present invention comprises a system and method for implementing a personal information mode in a television device, and includes personal information data that is selectably accessed from at least one remote information source. A display of the television device is configured to display a personal information interface to a system user. A personal information module of the television then automatically displays the personal information to the system user on the personal information interface.

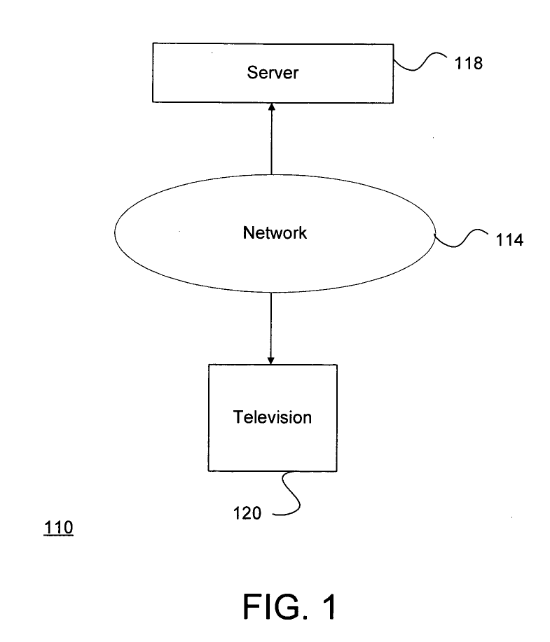

Referring now to FIG. 1, a block diagram of a personal information system 110 is shown, in accordance with one embodiment of the present invention. In the FIG. 1 embodiment, personal information system 110 may include, but is not limited to, a network 114, a server 118, and a television 120. In alternate embodiments, personal information system 110 may be implemented by utilizing components and configurations in addition to, or instead of, certain of those components and configurations discussed in conjunction with the FIG. 1 embodiment. For example, for purposes of illustration, a single television 120 is shown in FIG. 1. However, in actual practice, principles of the disclosed invention may readily be utilized by any number of different televisions. During the course of this disclosure of the present invention, the term “personal information” may be alternately represented by simply utilizing the initials “PI.”

In the FIG. 1 embodiment, television 120 may be implemented in any effective manner for use by a system user to view various types of television programming and other types of electronic content. In alternate embodiments, television 126 may be implemented as any other type of appropriate electronic device. For example, in certain embodiments, television 126 may be alternately implemented as a settop box, a personal computer, an audio-visual entertainment device, a cellular telephone, a personal digital assistant (PDA), or any type of stationary or portable consumer-electronics device.

In accordance with the present invention, television 120 advantageously supports a personal information (PI) mode that automatically provides various types of desired personal information for utilization by the system user. For example, the personal information may be displayed on television 120 as one or more PI display pages, and may include configurable and relevant information such as current news, weather, traffic, sports, and financial information. The PI mode may also support various local PI applications on television 120, such as a calendar, a clock, maps, games, and audio/video applications.

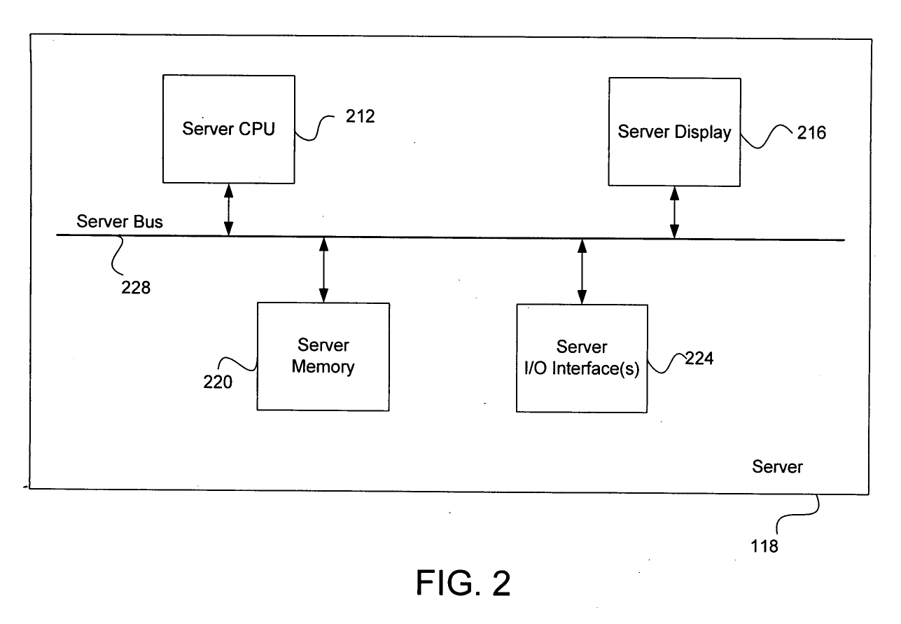

In certain embodiments, television 120 may access server 118 through network 114 to obtain current information for updating the personal information on the PI display page. In the FIG. 1 embodiment, network 114 may be implemented to include any desired types of electronic networks or other entities, including, but not limited to, a cable network and/or the Internet. In the FIG. 1 embodiment, server 118 may obtain the foregoing current information in any effective manner. In addition, in certain embodiments, server 118 may serve as a gateway device to provide appropriate links or connection information for television 120 to directly communicate with other information sources in network 114 or elsewhere to thereby obtain required personal information for presentation to the system user. Further details regarding the implementation and utilization of the FIG. 1 personal information system 110 are discussed below in conjunction with FIG. 2-10.

Referring now to FIG. 2, a block diagram for one embodiment of the FIG. 1 server 118 is shown, in accordance with the present invention. In the FIG. 2 embodiment, server 118 includes, but is not limited to, a server central processing unit (server CPU) 212, a server display 216, a server memory 220, and one or more server input/output interface(s) (server I/O interface(s)) 224. The foregoing components of server 118 may be coupled to, and communicate through, a server bus 228. In alternate embodiments, server 118 may alternately be implemented using components and configurations in addition to, or instead of, certain of those components and configurations discussed in conjunction with the FIG. 2 embodiment.

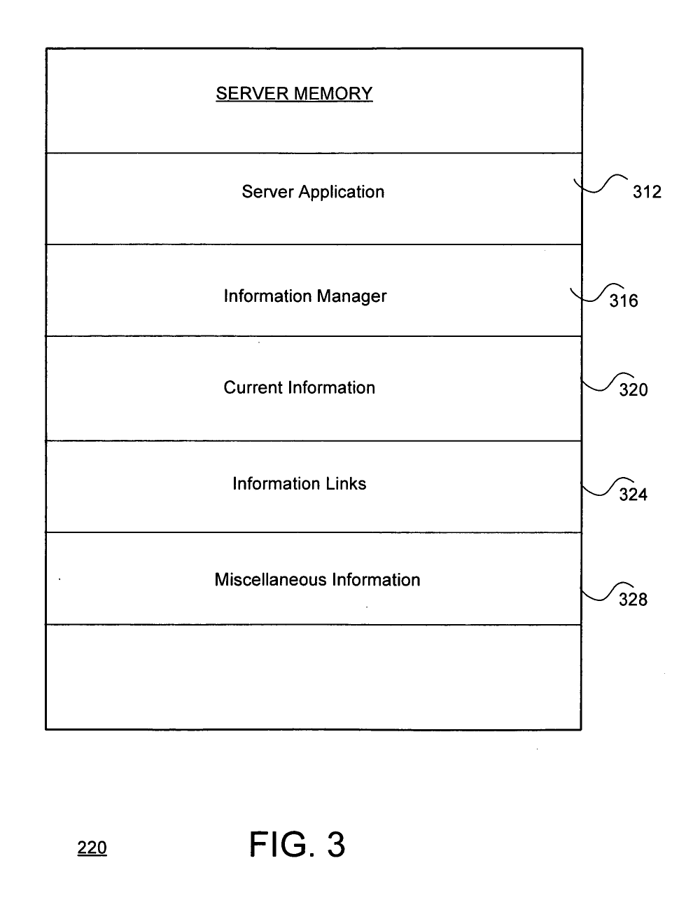

In the FIG. 2 embodiment, server CPU 212 may be implemented to include any appropriate and compatible microprocessor device that preferably executes software instructions to thereby control and manage the operation of server 118. The FIG. 2 server display 216 may include any effective type of display technology including a cathode-ray-tube monitor or a liquid-crystal display device with an appropriate screen for displaying various information to a server user. In the FIG. 2 embodiment, server memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of server memory 220 are further discussed below in conjunction with FIG. 3.

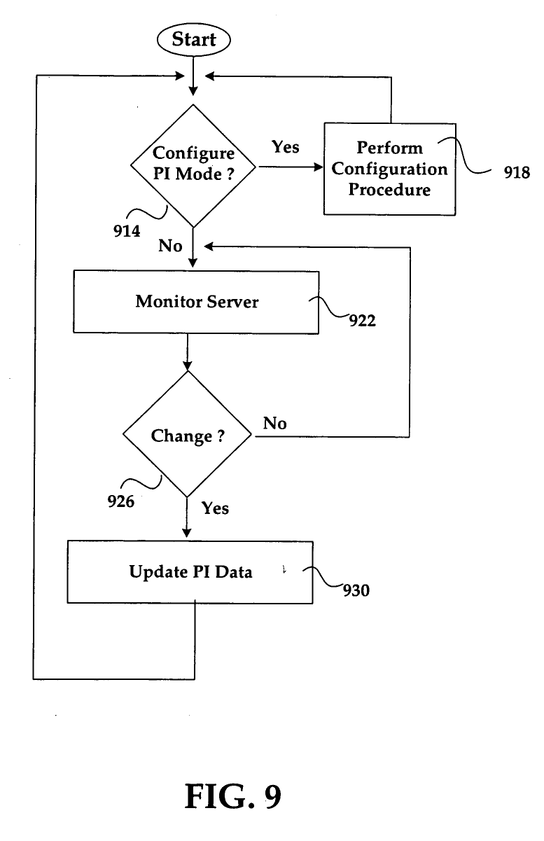

In the FIG. 2 embodiment, server I/O interface(s) 224 may include one or more input and/or output interfaces to receive and/or transmit any required types of information by network server 118. Server I/O interface(s) 224 may include one or more means for allowing a server user to communicate with network 114. The implementation and utilization of server 118 is further discussed below in conjunction with FIG. 9.

Referring now to FIG. 3, a block diagram for one embodiment of the FIG. 2 server memory 220 is shown, in accordance with the present invention. In the FIG. 3 embodiment, server memory 220 may include, but is not limited to, a server application 312, an information manager 316, current information 320, information links 324, and miscellaneous information 328. In alternate embodiments, server memory 220 may include various other components and functionalities in addition to, or instead of, certain those components and functionalities discussed in conjunction with the FIG. 3 embodiment.

In the FIG. 3 embodiment, server application 312 may include program instructions that are preferably executed by server CPU 212 (FIG. 2) to perform various functions and operations for server 118. The particular nature and functionality of server application 312 typically varies depending upon factors such as the specific type and particular functionality of the corresponding server 118. In the FIG. 3 embodiment, server 118 may utilize an information manager 316 for communicating with television 120 (FIG. 1) to provide appropriate current information 320 to support a PI mode, as discussed above in conjunction with FIG. 1.

In the FIG. 3 embodiment, server 118 may also provide information links 324 to allow television 120 to directly contact other information sources for obtaining additional required personal information to support the PI mode, as discussed above in conjunction with FIG. 1. In the FIG. 3 embodiment, miscellaneous information 328 may include any additional types of information, data, or software instructions for supporting the foregoing PI mode in television 120. Additional details regarding the operation and implementation of server 118 are further discussed below in conjunction with FIG. 9.

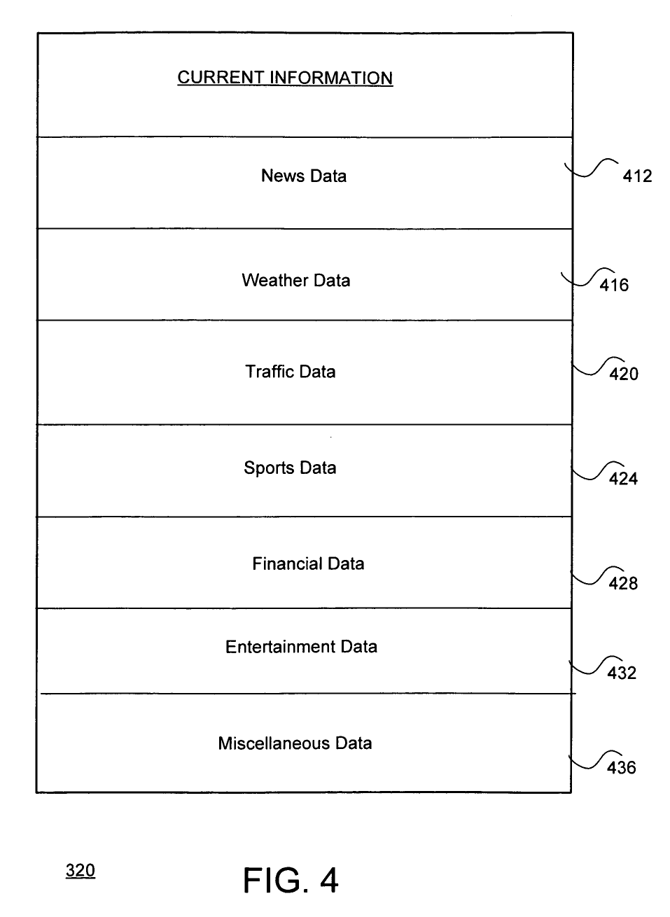

Referring now to FIG. 4, a diagram for one embodiment of the FIG. 3 current information 320 is shown, in accordance with the present invention. In the FIG. 4 embodiment, current information 320 includes, but is not limited to, news data 412, weather data 416, traffic data 420, sports data 424, financial data 428, entertainment data 432, and miscellaneous data 436. In the FIG. 4 embodiment, current information 320 is presented for purposes of illustration. In alternate embodiments, server 118 may provide current information 320 that includes elements and data in addition to, or instead of, certain of those elements and data discussed in conjunction with the FIG. 4 embodiment.

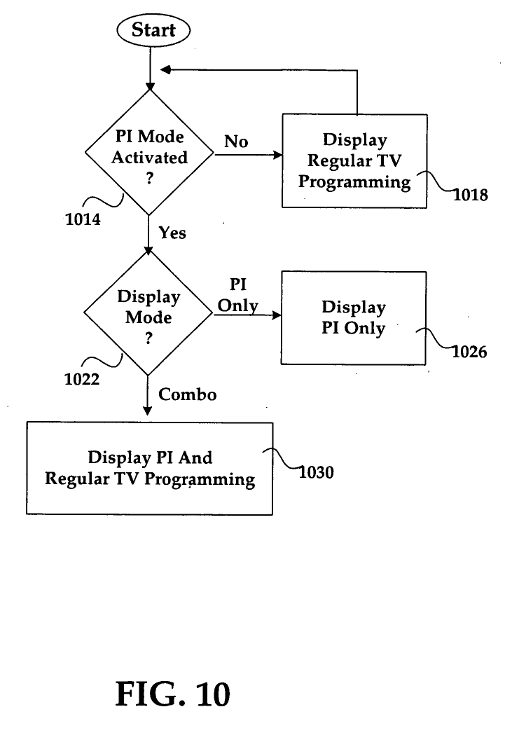

In the FIG. 4 embodiment, news data 412 may include any appropriate world, regional, or local news information. Similarly, weather data 416 and traffic data 420 may include current information regarding weather and traffic conditions from any specified location. In the FIG. 4 embodiment, sports data 424, financial data 428, and entertainment data 432 may include appropriate information regarding any selected sporting events, financial statistics, or entertainment information. Miscellaneous data 436 may include any additional information for supporting a personal information mode in one or more televisions 120 (FIG. 1). The utilization of current information 320 is further discussed below in conjunction with FIGS. 9-10.

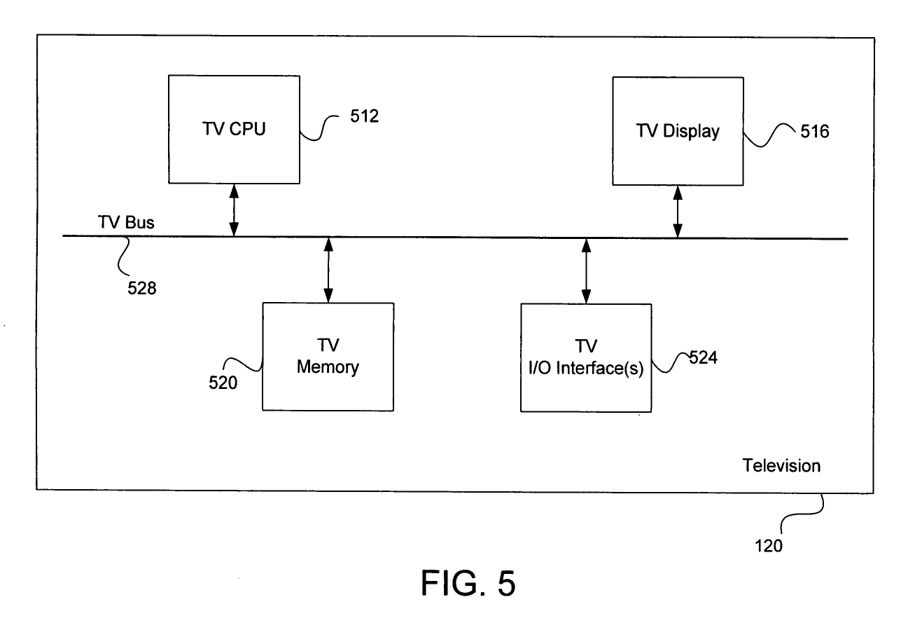

Referring now to FIG. 5, a block diagram for one embodiment of the FIG. 1 television 120 is shown, in accordance with the present invention. In the FIG. 5 embodiment, television 120 may include, but is not limited to, a TV central processing unit (TV CPU) 512, a TV display 516, a TV memory 520, and one or more TV input/output interface(s) (TV I/O interface(s)) 524. The foregoing components of television 120 may be coupled to, and communicate through, a TV bus 528.

In alternate embodiments, television 120 may readily be implemented using various components and configurations in addition to, or instead of, certain of those components and configurations discussed in conjunction with the FIG. 5 embodiment. Furthermore, in alternate embodiments, television 120 may be implemented as any other type of appropriate electronic device. For example, in certain embodiments, television 120 may be alternately implemented as a settop box, a personal computer, an audio-visual entertainment device, a cellular telephone, a personal digital assistant (PDA), or any type of stationary or portable consumer-electronics device.

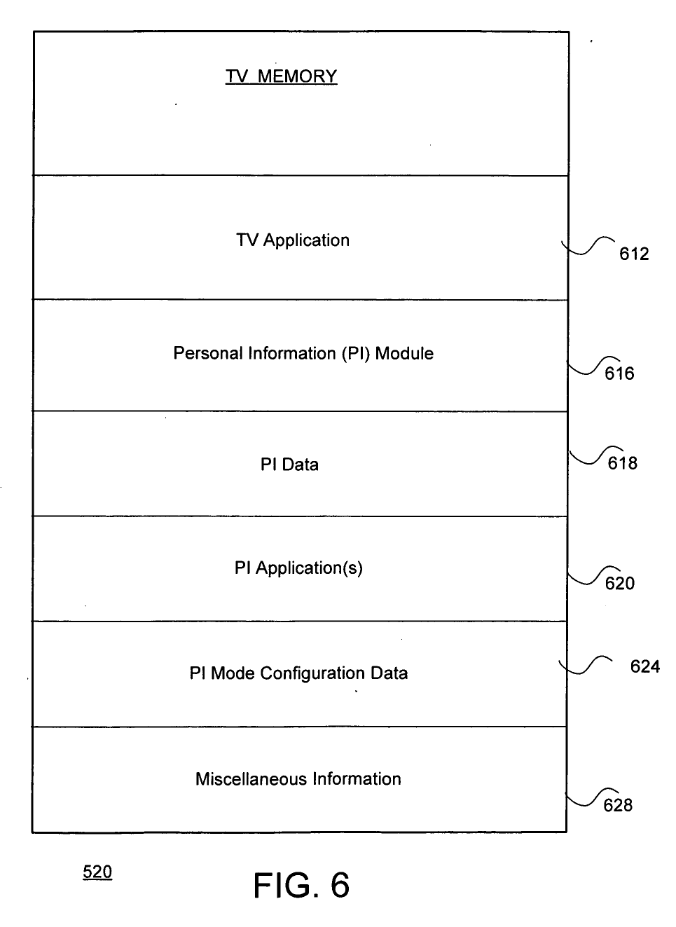

In the FIG. 5 embodiment, TV CPU 512 may be implemented to include any appropriate and compatible microprocessor device that preferably executes software instructions to thereby control and manage the operation of television 126. The FIG. 5 TV display 516 may include any effective type of display technology including a cathode-ray-tube monitor or a liquid-crystal display device with an appropriate screen for displaying various information to a device user. In the FIG. 5 embodiment, TV memory 520 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of TV memory 520 are further discussed below in conjunction with FIG. 6.

In the FIG. 5 embodiment, TV I/O interface(s) 524 may include one or more input and/or output interfaces to receive and/or transmit any required types of information by television 120. TV I/O interface(s) 524 may include one or more means for allowing a device user to communicate with other entities in electronic network 110 (FIG. 1A). For example, the foregoing means may include a keyboard device, a wireless remote-control device, a speech-recognition module with corresponding microphone, a graphical user interface with touch-screen capability, a hand-held device controller unit, or a selection button array mounted externally on television 120. In addition, TV I/O interfaces 524 may include one or more audio speakers for reproducing audio information. The utilization of television 120 in a PI mode is further discussed below in conjunction with FIGS. 9-10.

Referring now to FIG. 6, a block diagram for one embodiment of the FIG. 5 TV memory 520 is shown, in accordance with the present invention. In the FIG. 6 embodiment, TV memory 520 includes, but is not limited to, a TV application 612, a PI module 616, PI data 618, PI applications 620, and PI mode configuration data 624, and miscellaneous information 628. In alternate embodiments, TV memory 520 may include various components and functionalities in addition to, or instead of, certain of those components and functionalities discussed in conjunction with the FIG. 6 embodiment.

In the FIG. 6 embodiment, TV application 612 may include program instructions that are preferably executed by a TV CPU 512 (FIG. 5) to perform various functions and operations for a television 120. The particular nature and functionality of TV application 612 typically varies depending upon factors such as the specific type and particular functionality of the corresponding television 120.

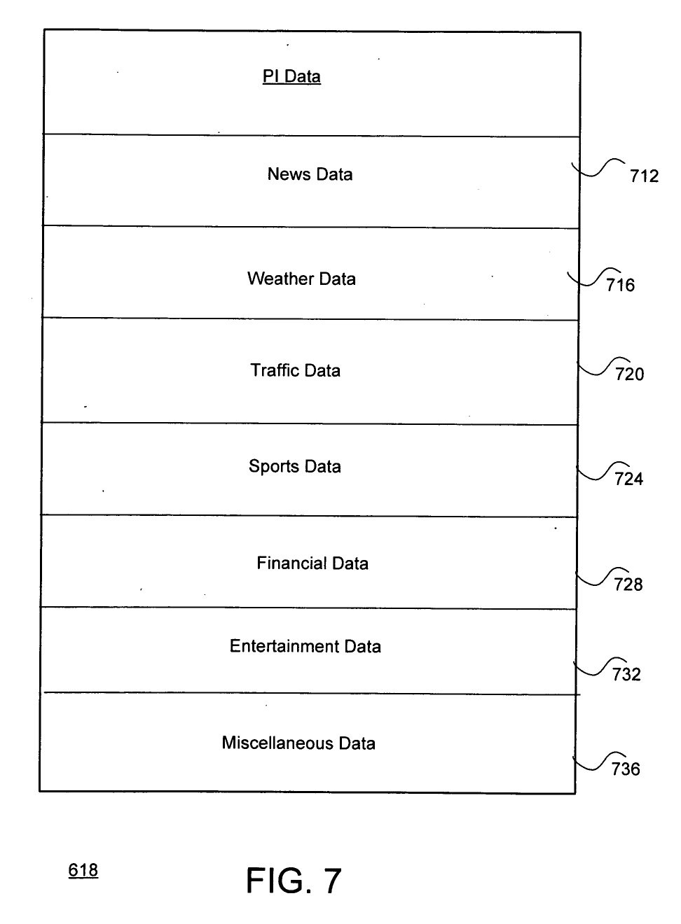

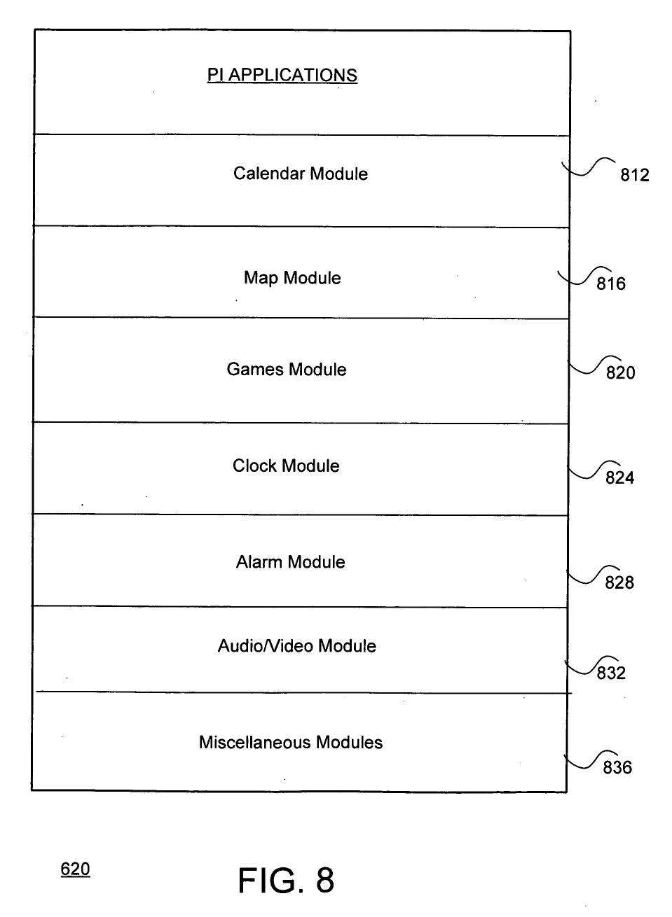

In the FIG. 6 embodiment, television 120 may utilize a PI module 616 for obtaining, managing, and displaying appropriate PI data 618 to support a PI mode, as discussed above in conjunction with FIG. 1. In certain embodiments, PI module 616 may obtain some or all of PI data 618 from current information 320 on server 118 (FIG. 1) or from other appropriate information sources in network 114 (FIG. 1). Examples of certain types of PI data 618 are discussed below in conjunction with FIG. 7. In the FIG. 6 embodiment, television 120 may also include one or more local PI applications 620 to provide additional functionality for the PI mode, as discussed above in conjunction with FIG. 1. Examples of certain PI applications 620 are further discussed below in conjunction with FIG. 8.

In the FIG. 6 embodiment, a system user may utilize PI module 616 to perform a PI mode configuration procedure to produce PI mode configuration data 624 to specify any desired characteristics, functionalities, or features of the PI mode. For example, PI mode configuration data may define specific types of displayed information, PI display page size(s) and location(s) on television 120, PI mode activation/deactivation time(s), PI display appearance attributes, and any other appropriate characteristics or parameters for the PI mode. In the FIG. 6 embodiment, miscellaneous information 628 may include any additional types of information, data, or software instructions for supporting the foregoing PI mode in television 120. Additional details regarding the operation and implementation of television 120 in the PI mode are further discussed below in conjunction with FIG. 9-10.

Referring now to FIG. 7, a block diagram for one embodiment of the FIG. 6 PI data 618 is shown, in accordance with the present invention. In the FIG. 7 embodiment, PI data 618 includes, but is not limited to, news data 712, weather data 716, traffic data 720, sports data 724, financial data 728, entertainment data 732, and miscellaneous data 736. In the FIG. 7 embodiment, PI data 618 is presented for purposes of illustration. In alternate embodiments, television 120 may utilize PI data 618 that includes elements and data in addition to, or instead of, certain of those elements and data discussed in conjunction with the FIG. 7 embodiment.

In the FIG. 7 embodiment, news data 712 may include any appropriate world, regional, or local news information that is selected by the system user. Similarly, weather data 716 and traffic data 720 may include current information regarding weather and traffic conditions from any specified location. In the FIG. 7 embodiment, sports data 724, financial data 728, and entertainment data 732 may include appropriate information regarding any user-selected sporting events, financial statistics, or entertainment information. Miscellaneous data 736 may include any additional information for supporting the PI mode in, television 120 (FIG. 1). The presentation of PI data 618 during the PI mode is further discussed below in conjunction with FIGS. 9-10.

Referring now to FIG. 8, a block diagram for one embodiment of the FIG. 6 PI applications 620 is shown, in accordance with the present invention. The FIG. 8 embodiment is presented for purposes of illustration, and in alternate embodiments, PI applications 620 may include components, functionalities, and information in addition to, or instead of, certain of those components, functionalities, and information discussed in conjunction with the FIG. 7 embodiment.

In the-FIG. 8 embodiment, PI applications 620 may include any desired types of local software programs to enhance the PI mode on television 120. In the FIG. 8 example, PI applications 620 include, but are not limited to, a calendar module 812 that displays a programmable calendar, a map module 816 that display selectable local, regional, and international map data, a games module that a system user may utilize to play electronic games on television 120.

In the FIG. 8 embodiment, PI applications 620 may also include a programmable clock module 824 that displays and increments any selectable time data, an alarm module 828 that may be programmed to produce an alarm or activate television 120 according to the system user's wishes. PI applications 620 may also include a audio/video module 832 that can selectively reproduce audio and/or video information from any desired local or remote source. Miscellaneous modules 836 may include any additional software programs for effectively supporting the PI mode in television 120 (FIG. 1).

Referring now to FIG. 9, a flowchart of method steps for supporting a personal information mode is shown, in accordance with one embodiment of the present invention. The flowchart of FIG. 9 is presented for purposes of illustration, and in alternate embodiments, the present invention may utilize steps and sequences other than those steps and sequences discussed in conjunction with the embodiment of FIG. 9.

In the FIG. 9 embodiment, in step 914, a personal information module 616 of a television 120 initially determines whether a PI mode configuration procedure has been initiated to allow a system user to configure a personal information mode for presenting various types of personal information on television 120. In step 918, if the PI mode configuration procedure has been initiated, then the PI module 616 interactively allows the system user to specify any supported operational characteristics for the personal information mode.

In step 922, the personal information module 616 monitors a server 118 through an intervening network 114 (FIG. 1). In step 926, personal information module 616 determines whether there has been any change in certain user-specified personal information that the server 118 provides to the television 120. If any changes have occurred in the user-specified personal information provided through the server 118, then the personal information module 616 accesses the current personal information and updates corresponding PI data 618 stored in a local TV memory 520. The FIG. 9 process may then return to foregoing step 914, and continue to monitor and update the PI data 618 to thereby provide timely and accurate information to the system user during the personal information mode.

Referring now to FIG. 10, a flowchart of method steps for utilizing a personal information mode is shown, in accordance with one embodiment of the present invention. The flowchart of FIG. 10 is presented for purposes of illustration, and in alternate embodiments, the present invention may utilize steps and sequences other than those steps and sequences discussed in conjunction with the embodiment of FIG. 10.

In the FIG. 10 embodiment, in step 1014, a personal information module 616 of a television 120 determines whether a personal information mode is currently activated (manually or automatically) for providing personal information to a system user. In step 1018, if the personal information mode is not activated, then television 120 may display regular television programming from any appropriate source in a normal TV display mode.

However, if the personal information mode is currently activated, then in step 1022, the personal information module 616 determines which PI display mode has been selected for the television 120. In step 1026, if a PI-only display mode has been selected, then the television 120 displays only one or more personal information display pages in any effective manner. For example, in certain embodiments, the one or more personal information display pages may be displayed using either a full screen or a partial screen of television 120.

In contrast, in step 1030, if a combination (combo) display mode has been selected, then the television 120 displays the one or more personal information display pages in conjunction with the regular television programming in any effective manner. For example, in certain embodiments, the one or more personal information display pages may be displayed as a smaller window (picture-in-picture) within the regular television programming on the television 120. For all of the foregoing reasons, the present invention therefore provides an improved system and method for implementing a personal information mode in an electronic device.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for implementing a personal information mode in an electronic device, comprising:
information data that is selectably accessed from at least one information source;
a display coupled to said electronic device for displaying a personal information interface to a system user; and
a personal information module that automatically displays said personal information to a system user on said personal information interface.

2. The system of claim 1 wherein said electronic device is implemented to include a television that supports said personal information mode.

3. The system of claim 1 wherein said at least one information source includes a server that said electronic device communicates with through an electronic network.

4. The system of claim 3 wherein said server functions as a gateway device to provide connection information for said personal information module to contact and obtain said personal information from one or more remote information sources through said electronic network.

5. The system of claim 1 wherein said personal information interface includes one or more personal information display pages that present said personal information to said system user.

6. The system of claim 1 wherein said personal information module obtains at least a portion of said personal information from a server through an electronic network.

7. The system of claim 6 wherein said electronic network includes an Internet network.

8. The system of claim 6 wherein said electronic network includes a cable television network.

9. The system of claim 6 wherein said server includes information links for said electronic device to directly connect with one or more remote information sources through said electronic network to obtain said personal information.

10. The system of claim 1 wherein said personal information includes news data, weather data, traffic data, sports data, financial data, and entertainment data.

11. The system of claim 1 wherein said electronic device includes one or more personal information applications that support user-selected functions during said personal information mode.

12. The system of claim 11 wherein said personal information applications include a calendar module, a map module, a games module, a clock module, an alarm module, and an audio/video module.

13. The system of claim 1 wherein said electronic device includes configuration data that defines operating characteristics of said personal information mode.

14. The system of claim 13 wherein said personal information module allows said system user to interactively perform a configuration procedure to create and locally store said configuration data.

15. The system of claim 1 wherein said personal information module monitors a server through an electronic network to detect any data changes in said personal information provided by said server, said personal information module updating locally-stored versions of personal information data to incorporate said data changes.

16. The system of claim 1 wherein said personal information mode is manually or automatically activated in said electronic device to display said personal information to said system user.

17. The system of claim 1 wherein said personal information module determines a currently-selected display mode for said personal information mode.

18. The system of claim 17 wherein said currently-selected display mode is a personal-information-only mode, said personal information module responsively instructing said display to present only said personal information interface to said system user.

19. The system of claim 17 wherein said currently-selected display mode is a combination mode, said personal information module responsively instructing said display to present both said personal information interface and normal display information to said system user.

20. A method for implementing a personal information mode in an electronic device, comprising:
accessing information data selectably from at least one information source;
displaying a personal information interface to a system user on a display coupled to said electronic device; and
utilizing a personal information module to automatically display said personal information to a system user on said personal information interface.
